(19) United States
(12) Patent Application Publication
(10) Pub. No.: US 2009/0107553 A1
(43) Pub. Date: Apr. 30, 2009

(54) HIGHLY ABRASION-RESISTANT TERIONOMER PIPE

(75) Inventors: Richard Allen Hayes, Beaumont, TX (US); Mark B. Kelly, Beaumont, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/263,028

(22) Filed: Oct. 31, 2008

Related U.S. Application Data
(60) Provisional application No. 60/984,153, filed on Oct. 31, 2007.

(51) Int. Cl. F17D 5/00; B32B 1/08; B21C 37/06; F16L 9/14

(52) U.S. Cl. 137/1; 428/35.7; 428/36.8; 428/35.9; 72/368; 138/145

(57) ABSTRACT

A pipe or tube article is disclosed that comprises an innermost layer having a thickness of about 0.001 to about 102 mm (0.00004 to 4 inches) comprising a polymeric composition comprising a terionomer composition made from a parent acid terpolymer composition made from an α-olefin having 2 to 10 carbons; about 12 to about 60 wt % of an α,β-ethylenically unsaturated carboxylic acid ester; and about 5 to about 25 wt % of an α,β-ethylenically unsaturated carboxylic acid having 3 to 8 carbons (based on the total weight of the parent acid terpolymer); wherein about 5 to about 90% of the carboxylic acids are neutralized with a metal ion to provide long lifetime, highly abrasion-resistant pipes for mining and other transportation uses. Methods for preparing the article and transporting abrasive materials through the article are also described.

This application claims priority to U.S. provisional application, Ser. No. 60/984153, field Oct. 31, 2007, the entire disclosure of which is incorporated herein by reference.

The invention relates to abrasion-resistant tubular articles such as pipes comprising terionomer layers that provide for the transport of particulates and slurries, methods and compositions to produce the articles, and methods of transporting abrasive materials through them.

### BACKGROUND OF THE INVENTION

Mining operations require the transport of highly abrasive particulate or slurry streams. The recovery of bitumen from oil sands is becoming increasingly important within the energy industry. Processing oil sand includes transporting and conditioning the oil sand as an aqueous slurry over kilometer lengths of pipe up to 1 meter in diameter. Processes for recovery of bitumen from oil sands are known (U.S. Pat. Nos. 4,255,433, 4,414,117, 4,512,956, 4,533,459, 5,039,227, 6,007,708, 6,096,192, 6,110,359, 6,277,269, 6,391,190, US2006/0016760, US2006/0249431, US2007/0023323, US2007/0025896, WO2006/060917, CA1251146, CA2195604, CA2227667, CA2420034, CA2445645, and CA2520943). Use of caustic to assist in the recovery process of oil from oil sands is also known (US2006/0016760 and US2006/0249431). Other mining operations that include the transport of highly abrasive particulate or slurry streams from the mine to processing refinery include, for example, iron ore, coal and coal dust, and the like, and in further non-mining transport processes, such as grain, sugar and the like.

Often, metal pipes, such as carbon steel or cast iron pipes, are used for the transport of these highly abrasive streams. They are expensive, heavy and only provide a temporary solution since they are eventually destroyed. To increase their lifetimes, the metal pipes may be rotated 90 degrees on their axes on a regular basis to provide a new transport surface. However, because of the pipe weight, this rotation is difficult and ultimately the entire pipe is worn out and must be replaced.

Use of plastic pipes, pipe liners and pipe coatings has been proposed to reduce these shortcomings. Material selection is critical. Many of the commonly available materials cannot stand up to such highly-abrasive mining streams and are quickly worn out. For example, high density poly(ethylene) pipes are generally used as liners for sanitary sewer and wastewater pipelines but they rapidly degrade under highly abrasive environments. U.S. Pat. No. 4,042,559 discloses abrasive granule-filled, partially-cured coatings for use in abrasion resistant coated pipes for the transport of mining slurries. U.S. Pat. No. 4,254,165 discloses processes to produce abrasion resistant pipes with 0.04-0.05-inch thick coatings of filled (such as sand) polyolefins, such as low and medium density poly(ethylene) and including poly(ethylene-co-acrylic acid). U.S. Pat. No. 4,339,506, WO90/10032, and CA1232553 disclose rubber liners for pipes. U.S. Pat. No. 4,215,178 discloses fluoropolymer-modified rubber pipe liners. US2006/0137757 and US2007/0141285 disclose fluoropolymer pipe liners. Polyurethane pipe coatings are known (U.S. Pat. No. 3,862,921, U.S. Pat. No. 4,025,670, US2005/0194718, US2008/0174110, GB2028461, JP02189379, JP03155937, and JP60197770). US2005/0189028 discloses metal pipe coated with a polyurethane liner to transport tar sand slurry. GB2028461 discloses an abrasion-resistant pipe lining comprising a urethane rubber thermoset embedded with the particles of the material to be transported (coal dust, grain or sugar) through transport of the materials during curing. Abrasion resistant pipes with elastomeric polyurea coatings are disclosed in U.S. Pat. No. 6,737,134. A shortcoming of the polyurethane coatings includes the highly complex processes for applying the coating to the metal pipe.

Use of ionomer compositions made from acid copolymer compositions comprising an α-olefin monomer and an α,β-ethylenically unsaturated carboxylic acid monomer as pipes, pipe liners and pipe coatings is known. For example, JP2000179752, JP2000352480, JP2000352479, JP2002249750 disclose 1.5 mm (0.05 inch) thick ionomer tubes for use as an anticorrosive lining for metal pipes designed for water service, wastewater and the like. JP08011230 and JP08259704 disclose heat-shrinkable, crosslinked ionomer tubes for the protection of pipes and cables. EP0586877 discloses heat-shrinkable, crosslinked ionomer tubes with wall thicknesses of 1.5 mm. JP3700192 discloses heat-shrinkable, foamed ionomer tubes. JP2000179752 discloses the use of epoxy primers to adhere ionomer tubes to water service metal pipes.

US2006/0154011 and JP63051135 disclose poly(ethylene) blend pipes with a minor ionomer component. JP2000034415 discloses glass reinforced nylon pipes that include a minor ionomer component. Multilayer coextruded pipes with ionomer layers are known (EP209396; JP2004114389; JP2004098515; JP2001041360; JP59131447; and JP59131448). JP3711305 discloses tubes made from ionomer compositions filled with 10-50 wt % inorganic fine-grain particles for use in lithium secondary batteries. U.S. Pat. No. 3,429,954, U.S. Pat. No. 3,534,465, US2006/0108016, JP2002248707, JP2002254493,JP2002257264,JP2002257265,JP2002327867, and US2005/0217747 disclose the use of poly(ethylene-co-(meth)acrylic acid) copolymers as adhesive layers to attach poly(ethylene) pipe liners to pipes. JP2002248707,JP2002254493,JP2002257264,JP2002257265, JP2002327867, JP2003294174, and US2005/0257848 disclose ionomers as adhesive layers to attach poly(olefin) pipe liners to steel pipes.

Metal articles coated with ionomers are known (U.S. Pat. Nos. 3,826,628, 4,049,904, 4,092,452 4,371,583, 4,438,162, 5,496,652, US2006/0233955; and WO00/10737). Ionomer powder coating compositions are known (U.S. Pat. Nos. 3,959,539, 5,344,883, 6,132,883, 6,284,311, 6,544,596 and 6,680,082). WO00/27892 discloses scratch and abrasion resistant ionomers neutralized with at least 2 metal ions for protective formulations. Acid copolymer powder coating compositions are known (U.S. Pat. No. 4,237,037 and U.S. Pat. No. 5,981,086). Metal articles powder coated with ionomers are known (U.S. Pat. No. 3,991,235, 4,910,046, 5,036,134, 5,155,162, and 6,284,311). Metal powder coatings comprising anhydride-grafted polyolefins are disclosed in U.S. Pat. No. 4,048,355. Metal powder coatings comprising acid copolymers are disclosed in U.S. Pat. No. 4,237,037. Corrosion-resistant zinc metal-filled ionomer metal coatings are disclosed in U.S. Pat. No. 5,562,989. Corrosion-resistant zinc metal-filled acid-grafted polyolefin metal coatings are disclosed in U.S. Pat. No. 5,091,260. JP61045514 discloses ionomer coatings for metal pipes. U.S. Pat. No. 4,407,893 discloses powder coating processes to produce abrasion resistant pipes with 0.04-inch thick coatings of sand-filled blends comprising polyethylenes and ionomers. U.S. Pat. No. 5,638,871 discloses the extrusion coating of the outer surface of a metal pipe with ionomer compositions. Abrasion resistant ionomer coatings on glass articles are known (U.S. Pat. Nos. 3,836,386, 3,909,487, 3,922,450, 3,984,608 and EP0798053). Abrasion resistant ionomer coatings are disclosed in US2004/0115399 and US2007/0504331.

A shortcoming of previous ionomer pipes, pipe liners and pipe coatings is low abrasion resistance resulting in short service lifetimes.

### SUMMARY OF THE INVENTION

The invention is directed to a pipe- or tube-formed article having an innermost layer wherein

the innermost layer has a thickness of about 0.001 to about 102 mm and comprises a terionomer composition;

the terionomer is made from an acid terpolymer comprising an α-olefin having 2 to 10 carbons, about 12 to about 60 wt %, based on the total weight of the parent acid terpolymer composition, of an α,β-ethylenically unsaturated carboxylic acid ester, and about 5 to about 25 wt % based on the total weight of the parent acid terpolymer composition of an α,β-ethylenically unsaturated carboxylic acid having 3 to 8 carbons; and about 5 to about 90% of the carboxylic acids are neutralized with a metal ion.

The invention is also directed to a method comprising pulling or inserting an article into the interior surface of a metal pipe to produce a terionomer-lined metal pipe wherein the article is characterized above.

The invention also provides a method comprising laying up a film or sheet or comprising a terionomer composition into the interior surface of a metal pipe; heating the metal pipe above the softening point of the terionomer composition; and allowing the metal pipe to cool to produce a terionomer-lined metal pipe wherein the terionomer is characterized above.

The invention also provides a method for transporting an abrasive material comprising obtaining a pipe- or tube-formed article as described above; preparing an abrasive material composition suitable for flowing through the article; flowing the abrasive material composition into one end of the pipe- or tube-formed article and receiving the abrasive material composition out of the other end of pipe- or tube-formed article.

### DETAILED DESCRIPTION OF THE INVENTION

All publications, patent applications, patents, and other references mentioned herein are incorporated by reference in their entirety.

Trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight. When an amount, concentration, or other value or parameter is given as a range, all ranges formed from any pair of any upper range limit or preferred value and any lower range limit or preferred value, regardless of whether ranges are separately disclosed. Where a range of numerical values is recited herein, the range is intended to include the endpoints thereof, and all integers and fractions within the range. It is not intended that the scope of the invention be limited to the specific values recited when defining a range.

Term “about” is used in describing a value or an end-point of a range, the disclosure includes the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where applicants have defined an invention or a portion thereof with an open-ended term such as “comprising,” the description is interpreted to also describe such an invention using the terms “consisting essentially of” or “consisting of.”

Use of “a” or “an” are employed to describe elements and components of the invention. This is done merely for convenience and to give a general sense of the invention. This description includes one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The terionomer compositions and methods described herein may be used to provide long lifetime, highly abrasion-resistant pipes for a wide variety of mining and other transportation uses over a wide range of environmental conditions. High burst strength may be another attribute of the pipes.

Terionomer Layer Composition

By thermoplastic terionomer polymer, terionomer polymer, terionomeric polymer, terionomer, and similar terms used herein, reference is made to a thermoplastic terionomer made from a parent acid terpolymer comprising copolymerized units of an α-olefin having 2 to 10 carbons; about 12 to about 60 wt % of copolymerized units of an α,β-ethylenically unsaturated carboxylic acid ester; and about 5 to about 25 wt % of copolymerized units of an α,β-ethylenically unsaturated carboxylic acid having 3 to 8 carbons (based on the total weight of the parent acid terpolymer); wherein about 5 to about 90% of the carboxylic acids are neutralized with a metal ion. The terionomers are made from the parent acid terpolymers through neutralization of a portion of the carboxylic acid moieties with basic compounds comprising metal ions.

The α-olefin comonomers preferably incorporate from 2 to 10 carbon atoms. Preferred α-olefins include but are not limited to ethylene, propylene, 1-butene, 1-pentene, 1-hexene, 1-heptene, 3-methyl-1-butene, 4-methyl-1-pentene, and the like and mixtures thereof. More preferably, the α-olefin is ethylene.

Preferably, the parent acid terpolymer comprises about 15 to about 30 and more preferably about 17 to about 25 wt % of copolymerized units of the α,β-ethylenically unsaturated carboxylic acid ester, based on the total weight of the parent acid terpolymer. Preferred α,β-ethylenically unsaturated carboxylic acid ester comonomers include methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate and the like and mixtures thereof. Most preferred are methyl acrylate, ethyl acrylate, isopropyl acrylate, butyl acrylate, and mixtures thereof.

Preferably, the parent acid terpolymer comprises about 7 to about 20 wt %, or more preferably about 8 to about 19 wt %, of copolymerized units of the α,β-ethylenically unsaturated carboxylic acid, based on the total weight of the parent acid terpolymer. Preferred α,β-ethylenically unsaturated carboxylic acid comonomers include acrylic acid, methacrylic acid, itaconic acid, maleic acid, maleic anhydride, fumaric acid, monomethyl maleic acid, and mixtures thereof. Most preferred are acrylic acid, methacrylic acid and mixtures thereof.

The parent acid dipolymers may be polymerized as disclosed in U.S. Pat. Nos. 3,404,134, 5,028,674, 6,500,888, and 6,518,365. They may be neutralized as disclosed in U.S. Pat. No. 3,404,134. The ionomers are neutralized from about 5 to about 90%, or preferably, from about 10 to about 50%, or more preferably, from about 20 to about 40%, with metal ions, based on the total carboxylic acid content of the parent acid copolymers as calculated for the non-neutralized parent acid copolymers.

The metal ions may be monovalent, divalent, trivalent, multivalent, or mixtures thereof including sodium, potassium, lithium, silver, mercury, copper, beryllium, magnesium, calcium, strontium, barium, copper, cadmium, mercury, tin, lead, iron, cobalt, nickel, zinc, aluminum, scandium, iron, yttrium, titanium, zirconium, hafnium, vanadium, tantalum, tungsten, chromium, cerium, iron, and the like, and mixtures thereof. When the metallic ion is multivalent, complexing agents such as stearate, oleate, salicylate, and phenolate radicals may be included, as disclosed in U.S. Pat. No. 3,404,134. The metallic ions are preferably monovalent or divalent metallic ions. More preferably, the metallic ions are selected from the group consisting of sodium, lithium, magnesium, zinc and mixtures thereof, yet more preferably, sodium, zinc and mixtures thereof. Most preferably, the metallic ions are zinc.

The ionomer may have Shore D hardness (ASTM D2240, ISO 868) from about 30 to about 70, notably about 30 to about 60, about 40 to about 50, or about 60 to about 70.

Suitable terionomers are available under the SURLYN tradename from E. I. du Pont de Nemours and Company, Wilmington, Del. (DuPont).

The terionomer compositions may include additives known in the art. The additives include plasticizers, processing aids, flow enhancing additives, flow reducing additives, lubricants, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. One of ordinary skill in the art will recognize that additives may be added to the terionomer composition using techniques known in the art or variants thereof, and will know the proper amounts for addition based upon typical usage. The total amount of additives used in the terionomer composition may be up to about 15 weight % based upon the weight of the composition.

The terionomer compositions may contain additives that effectively reduce the melt flow of the resin, and may be present in any amount that permits production of thermoset compositions. Use of such additives may enhance the upper end-use temperature and reduce creep of the pipes produced therefrom. Such cured terpolymer compositions may also have enhanced resistance to the low molecular weight aromatic fraction and naptha commonly found in oil sand slurries.

Melt flow reducing additives include organic peroxides such as 2,5-dimethylhexane-2,5-dihydroperoxide, 2,5-dimethyl-2,5-di(tert-butylperoxy)hexane-3,di-tert-butyl peroxide, tert-butylcumyl peroxide, 2,5-dimethyl-2,5-di(tert-butylperoxy)hexane, dicumyl peroxide, α,α′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof. Preferably the organic peroxides decompose at a temperature of about 100° C. or higher to generate radicals. More preferably, the organic peroxides have a decomposition temperature that affords a half life of 10 hours at about 70° C. or higher to provide improved stability for blending operations. The organic peroxides may be added at a level of about 0.01 to about 10 wt %, or about 0.5 to about 3 wt %, based on the total weight of the terionomer composition.

If desired, initiators, such as dibutyltin dilaurate, may also be present in the terionomer composition at a level of about 0.01 to about 0.05 wt %, based on the total weight of the terionomer composition. Also if desired, inhibitors such as hydroquinone, hydroquinone monomethyl ether, p-benzoquinone, and methylhydroquinone, may be added for the purpose of enhancing control of the reaction and stability. The inhibitors may be added at a level of less than about 5 wt %, based on the total weight of the composition.

Alternative melt flow reducing additives include known peroxide-silanol additives that often include a peroxide (as described above), a silane and a catalyst. These additive systems provide moisture curable materials. Such systems may be added in a concentrate form, such as commercially available under the SILCAT trademark (Momentive Performance Materials, Wilton, Conn., USA).

The terionomer composition may further comprise about 0.1 to about 80 weight % filler based on the total weight of the filled composition.

Preferably, the filler is abrasion-resistant filler. The filler may be reinforcing filler or non-reinforcing filler. Specific examples of preferred reinforcing fillers include high strength fibers such as fiberglass, continuous glass fiber, polyaramide fiber, KEVLAR (a product of DuPont, Wilmington, Del.), graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, polyamide and the like. For example, US2006/0124188 and US2006/0151042 disclose fiber-reinforced pipe liners. Specific examples of non-reinforcing fillers include particles of abrasion-resistant minerals, marble, slate, granite, sand, potters' sand, silicates, limestone, clay, glass, quartz, metallic powders, aluminum powders, stainless steel powders, zinc metal, refractory metal borides (such as borides of aluminum, niobium, silicon, tantalum, titanium, tungsten, and zirconium), carbides (such as carbides of boron, niobium, silicon, tantalum, titanium, tungsten and zirconium), nitrides (such as nitrides of aluminum, boron, niobium, silicon, tantalum, titanium, tungsten and zirconium), oxides (such as oxides of aluminum, niobium, silicon, tantalum, titanium, tungsten and zirconium), silicon carbide, alumina, fused combinations of alumina and zirconia, calcium carbonate, barium sulfate, magnesium silicate and the like and combinations thereof.

The size of the filler incorporated in the terionomer composition depends on the thickness and diameter of the terionomer pipe and should be smaller than the thickness of the terionomer pipe. Preferably, a mixture of particle sizes is used to provide a higher density (percentage by volume) of filler incorporated. For abrasion-resistant fillers, this will result in higher abrasion resistance of the filled pipe. Filled polymeric pipes are known (U.S. Pat. Nos. 3,498,827; 4,042,559; 4,254,165; 4,407,893; 5,091,260; 5,562,989; and GB2028461).

Terionomer Pipe

The article in the form of a pipe comprising the terionomer composition comprises an innermost layer having a thickness of about 0.001 to about 102 mm (about 0.00004 to about 4 inches) of the terionomer composition. The pipe may have a hollow circular profile and the wall thickness may be generally uniform around the circumference of the pipe. This should not be taken as limiting. The pipe may have any profile and the wall thickness may vary around the circumference of the pipe as desired. The terionomer composition is positioned as the innermost layer to provide superior abrasion-resistance. The terionomer pipe thickness provides not only a long lifetime under extreme abrasive enduse conditions, but also provides desirable high burst strength under the high temperature conditions contemplated herein. Preferably, the terionomer layer has a thickness of about 3.2 to about 102 mm (about 0.125 to about 4 inches), or about 6.3 to about 76 mm (about 0.25 to about 3 inches), or about 13 to about 51 mm (about 0.5 to about 2 inches) to provide greater levels of enduse lifetime, burst strength and temperature resistance.

The terionomer pipe may have any dimensions (including outside diameter, inside diameter and length) required to meet the end use needs. For example but not limitation, the terionomer pipe preferably has an outer diameter (OD) of about 2.54 to about 254 cm (about 1 to about 100 inches), more preferably, about 25.4 to about 152 cm (about 10 to about 60 inches) and most preferably, about 51 to about 102 cm (about 20 to about 40 inches). For example but not limitation the terionomer pipe preferably has a length of about 1.5 to about 12.2 m (about 5 to about 40 feet), more preferably about 3.1 to about 9.1 m (about 10 to about 30 feet) and most preferably about 5.5 to about 6.7 m (about 18 to 22 feet) to provide a convenient length for storage, transport, handling and installation.

The terionomer pipe may be produced by any suitable process. For example, the terionomer pipe may be formed by melt extrusion, melt coextrusion, slush molding, rotomolding, rotational molding or any other procedures known in the art. For example, the terionomer pipe may be produced by rotational or slush molding processes. The terionomer composition may be in the form of powder, microbeads or pellets for use in rotational molding processes. Methods for rotational molding of pipes are known (U.S. Pat. No. 4,115,508; U.S. Pat. No. 4,668,461; and ZA9607413). ZA9607413 discloses wear-resistant composite pipe linings produced through rotational molding a mixture of a polymeric material with an abrasion-resistant particulate material. Methods for rotational molding with polymer powders are known (U.S. Pat. Nos. 3,784,668; 3,876,613; 3,891,597; 3,974,114; 4,029,729; 4,877,562; 5,366,675; 5,367,025; and 5,759,472). U.S. Pat. No. 3,974,114 discloses rotational molding of articles with poly(ethylene-co-acrylic acid) copolymer powders. Methods for rotational molding with polymer microbeads are known (U.S. Pat. No. 5,886,068; EP1422059 and EP1736502). U.S. Pat. No. 5,886,068 discloses rotational molding processes that use blends of micropellets which generally include ionomers. Methods for rotational molding with polymer pellets are known (U.S. Pat. No. 4,032,600; U.S. Pat. No. 4,185,067; U.S. Pat. No. 5,232,644; and EP0778088). Methods for slush molding with polymer powders are known (U.S. Pat. No. 6,218,474 and EP1169390). EP1169390 discloses ionomer powder compositions used in slush molding processes.

Preferably, the terionomer pipes are formed by melt extrusion and coextrusion processes that are particularly preferred processes for formation of “endless” products. Methods for extruding polymers in the form of pipe are known (U.S. Pat. Nos. 2,502,638; 3,538,209; 3,561,493; 3,755,168; 3,871,807; 3,907,961; 3,936,417; 4,069, 001; 4,123,487; 4,125,585; 4,196,464; 4,203,880; 4,301,060; 4,377,545; 4,402,658; 4,465,449; 4,663,107; 4,888,148; 5,028,376; 5,089,204; 5,514,312; 5,518,036; 5,643,526; 5,842,505; 5,976,298; 6,174,981; 6,241,840; 6,418,732; 6,469,079; 6,787,207; US20050167892; US20070117932; EP0222199; EP1574 772; WO95/07428; WO2000/018562; WO2006/090016; and WO2006/134228). The molten polymer is forced through an annular die and a mandrel to provide the hollow circular profile of the pipe with the inner pipe diameter controlled by the size of the mandrel. The diameter of the pipe may also be controlled through the application of air pressure inside the pipe. The outer diameter may be controlled with external sizing dies or sleeves. The pipe is cooled to form the final shape. Multilayer pipe is produced similarly using a multilayer annular die that is fed by two or more extruders.

Multilayer Terionomer Pipe

The article may be in the form of a multilayer pipe comprising an innermost layer of the terionomer composition and an outside layer comprising a polymeric material. Examples of preferred polymeric materials for the outside layer include poly(meth)acrylics, polyacrylates, urethane modified polyacrylics, polyester modified polyacrylics, polystyrenes, polyolefins, polyethylenes (such as high density polyethylene, low density polyethylene, linear low density polyethylene, ultralow density polyethylene), polypropylenes, polyurethanes, polyureas, epoxy resins, polyesters (such as poly(ethylene terephthalate), poly(1,3-propyl terephthalate), poly(1,4-butylene terephthalate), PETG, poly(ethylene-co-1,4-cyclohexanedimethanol terephthalate)), alkyd resins, polyamides (such as nylons, nylon 6, nylon 46, nylon 66, nylon 612), polyamideimides, polyvinyls, phenoxy resins, amino resins, melamines, chlorine-containing resins, chlorinated polyethers, fluorine-containing resins, polyvinyl acetals, polyvinyl formals, poly(vinyl butyrate)s, polyacetylenes, polyethers, silicone resins, ABS resins, polysulfones, polyamine sulfones, polyether sulfones, polyphenylene sulfones, polyvinyl chlorides, polyvinylidene chlorides, polyvinyl acetates, polyvinyl alcohols, polyvinyl carbazoles, butyrals, polyphenylene oxides, polypyrroles, polyparaphenylenes, ultraviolet-curing resins, cellulose derivatives, diethylene glycol bis-allyl carbonate poly-4-methylpentene, polytetrafluoroethylene, polytrifluoroethylene, polyvinylidene fluoride, poly(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), acid copolymers, acid terpolymers, poly(ethylene-co-(meth)acrylic acid), ionomers, ionomer terpolymers, metal salts of poly(ethylene-co-(meth)acrylic acid), poly((meth)acrylates), poly(ethylene-co-carbon monoxide), poly(ethylene-co-vinyl acetate), poly(ethylene-co-vinyl alcohol), polybutylene, poly(cyclic olefins), syndiotactic polystyrene, poly(4-hydroxystyrene), novalacs, poly(cresols), polycarbonates, poly(bisphenol A carbonate), polysulfides, poly(phenylene sulfide), poly(2,6-dimethylphenylene oxide), elastomers, rubbers, thermoplastic elastomers and the like and copolymers thereof and mixtures thereof.

More preferably, the polymeric materials are selected from the group consisting of rubbers, elastomers, thermoplastic elastomers, acid copolymers, ionomers and the like and combinations thereof. Rubbers and elastomers are generally categorized as diene elastomers, saturated elastomers, thermoplastic elastomers and inorganic elastomers. Specific examples of rubbers and elastomers include natural rubber, polyisoprene, butyl rubber (copolymer of isobutylene and isoprene), polybutadiene, styrene butadiene (SBR, copolymer of polystyrene and polybutadiene), nitrile rubber (copolymer of polybutadiene and acrylonitrile, also referred to as “buna N rubbers”), silicone RTV, FKM VITON (DuPont) (copolymer of vinylidene fluoride and hexafluoropropylene), SANTOPRENE (Advanced Elastomer Systems, LP, Akron, Ohio), fluorosilicone rubber, EPM and EPDM rubber (ethylene propylene rubber, a copolymer of polyethylene and polypropylene), polyurethane rubber, polyurea rubber, resilin, polyacrylic rubber (ABR), epichlorohydrin rubber (ECO), polysulfide rubber, chlorosulfonated polyethylene (CSM, HYPALON (DuPont)) and the like. Thermoplastic elastomers are generally categorized as styreneics (S-TPE), copolyesters (COPE), polyurethanes (TPU), polyamides (PEBA), polyolefin blends (TPO), polyolefin alloys (TPV), reactor TPO (R-TPO), polyolefin plastomers (POP), polyolefin elastomers (POE) and the like. Acid terpolymers are made from α-olefins, α,β-ethylenically unsaturated carboxylic acids and preferably about 10 to about 25 wt % other unsaturated comonomers (all as described above).

The polymer material layer may have any thickness. Preferably, the polymer material layer is about 0.1 to about 102 mm (about 0.004 to about 4 inches), or about 1 to about 25.4 mm (about 0.04 to about 1 inch) or about 2.5 to about 12.7 mm (about 0.1 to about 0.5 inch) thick.

Tielayers may be included between any of the layers to enhance the adhesion between the layers. Any material may be used in tielayers, such as anhydride- or acid-grafted materials. Typically tielayers are anhydride- or acid-grafted materials. The preferred anhydrides and acids are α,β-ethylenically unsaturated carboxylic acid comonomers selected from the group consisting of acrylic acid, methacrylic acid, itaconic acid, maleic acid, maleic anhydride, fumaric acid, monomethyl maleic acid, and mixtures thereof. Most preferred anhydrides and acids are selected from the group consisting of acrylic acid, maleic anhydride and mixtures thereof. Preferably, the materials to be grafted are selected from the preferred polymeric materials recited above.

Fiber-Reinforced Terionomer Pipe

The article may be in the form of a multilayer pipe comprising an innermost layer having a thickness of about 0.001 to about 102 mm (0.00004 to 4 inches) comprising the terionomer composition and an outer layer comprising a fiber reinforcement and optionally a thermoset resin.

The article may be in the form of a multilayer pipe comprising an innermost layer having a thickness of about 0.001 to about 102 mm (0.00004 to 4 inches) comprising the terionomer composition; an intermediate layer comprising a polymeric material; and an outer layer comprising a fiber reinforcement and optionally a thermoset resin.

The fiber reinforcement may be a filament, warp yarn, tape, unidirectional sheet, mat, cloth, knitted cloth, paper, non-woven fabric or woven fabric, or mixtures thereof. The fiber preferably comprises a high strength fiber such as fiberglass, continuous glass fiber, polyaramide fiber, aramid fiber, graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, polyamide and the like, and is preferably about 3 to about 30 microns thick.

The fiber may be impregnated with a resin (“prepreg”), such as thermoplastic or preferably thermoset resins. Suitable resins for impregnating the fiber layers include polyester, aromatic, aliphatic, cycloaliphatic or anhydride epoxy resins, vinylester, vinyl, acrylic, modified acrylic, urethane, phenolic, polyimide, bismaleimide, polyurea, siloxane-modified resins and the like and combinations thereof.

Fiber-reinforcement of thermoplastic pipe is known (U.S. Pat. Nos. 4,081,302; 4,521,465; 5,629,062; 5,931,198; 6,737,134; 7,018,691; US2006/0151042; and WO2004/068016).

An adhesive may be applied to the terionomer pipe and multilayer terionomer pipe prior to the application of the exterior reinforcement layer and/or an adhesive may be applied to the reinforcement layer after its application to the terionomer pipe and multilayer terionomer pipe. The exterior surface of the terionomer pipe and multilayer terionomer pipe may be heated to enhance the adhesion and/or embedding of the reinforcement layer. Suitable adhesives may include the impregnated resins described above or any adhesive known in the art.

The fiber reinforcement may be applied to the terionomer pipe and multilayer terionomer pipe by any known method. For example, the fiber reinforcement may be applied using known filament winding processes through winding the fiber reinforcement onto the terionomer pipe and multilayer terionomer pipe or by wrapping the fiber reinforcement around the terionomer pipe and multilayer terionomer pipe.

Terionomer-Lined Metal Pipe

The article may be in the form of a multilayer pipe comprising an innermost layer having a thickness of about 0.001 to about 102 mm (0.00004 to 4 inches) comprising the terionomer composition and an outer layer comprising a metal, preferably in the form of a metal pipe.

The monolayer or multilayer terionomer composition (such as in the form of pipe, film, or sheet) may be attached (adhered) to the metal outer layer or not attached. The terionomer or multilayer terionomer compositions may be self-adhered to the metal layer or adhered through the use of an adhesion primer, coating, or layer. As used herein, when the terionomer composition is said to be “self-adhered” to the metal layer, it is meant that there is no intermediate layer such as a primer or thin adhesive layer between the metal and the terionomer or multilayer terionomer composition. The terionomer compositions described herein have the advantage of forming high adhesion to the metal pipe.

The pipe may comprise an innermost layer comprising the terionomer composition; an intermediate layer comprising a polymer material (such as those polymeric materials described above); and an outer layer comprising metal.

The pipe may comprise an innermost layer comprising the terionomer composition; an intermediate layer comprising a polymer material; and an outer layer comprising metal, wherein the terionomer layer is adhered to the polymer material layer and the polymer material layer is adhered to the metal layer.

The pipe may comprise an innermost layer comprising the terionomer composition; an intermediate layer comprising a polymer material; and an outer layer comprising metal, wherein the terionomer layer is self-adhered to the polymer layer and the polymer layer is self-adhered to the metal layer.

The pipe may further comprise an intermediate layer comprising a fiber reinforcement material comprising a high strength fiber and optionally a thermoset resin as described above.

Preferably, the metal pipe comprises carbon steel, steel, stainless steel, cast iron, galvanized steel, aluminum, copper and the like. More preferably the metal pipe comprises carbon steel to provide the physical properties required for the material conveying processes contemplated herein.

The metal pipe may have any dimensions, including thickness, outer diameter, inner diameter and length suitable for the intended use. The pipe may have a hollow, substantially circular profile and the wall thickness may be generally uniform around the circumference of the pipe, or the pipe may have any profile and the wall thickness may vary around the circumference of the pipe as desired. For example but not limitation, the metal pipe may have a thickness of about 6.3 to about 51 mm (about 0.25 to about 2 inches, about 9.5 to about 38 mm (about 0.375 to about 1.5 inches) or about 13 to about 25.4 mm (about 0.5 to about 1 inch). For example but not limitation, the metal pipe may have an outer diameter (OD) of about 5.1 to about 254 cm (about 2 to about 100 inches), about 25.4 to about 152 cm (about 10 to about 60 inches) or about 51 to about 102 cm (about 20 to about 40 inches). For example but not limitation the metal pipe may have a length of about 1.5 to about 12.2 m (about 5 to about 40 feet), about 3.1 to about 9.1 m (about 10 to about 30 feet) or about 5.5 to about 6.7 m (about 18 to 22 feet) to provide a convenient length for storage, transport, handling and installation.

The terionomer-lined metal pipe may be produced by any known method. Monolayer or multilayer terionomer pipe may serve as a liner for a metal pipe. Methods for lining a pipe with a polymeric liner are known (e.g., U.S. Pat. No. 3,315,348, 3,429,954, 3,534,465, 3,856,905, 3,959,424, 4,207,130, 4,394,202, 4,863,365, 4,985,196, 4,998,871, 5,072,622, an 6,723,266; US2006/0093436; US2006/0108016; US2006/0124188; US2006/0151042; and EP0848659).

The inside surface of the metal pipe may be pretreated to provide enhanced adhesion and stability. Such treatments include descaling by sand-, metal grit- or shot-blasting, acid etching, cleaning the metal surface through solvent or chemical washes to remove grease and/or oxide layers, and the application of adhesion primers, coatings, or layers.

A terionomer-lined metal pipe may be prepared by pulling or inserting a preformed terionomer pipe or multilayer terionomer pipe into a preformed metal pipe wherein the outer diameter of the terionomer pipe is less than the interior diameter of the metal pipe. This method to produce a terionomer-lined metal pipe includes the following embodiments.

The method comprises (i) pulling or inserting a pre-formed terionomer pipe or multilayer terionomer pipe into the metal pipe; (ii) heating the terionomer-lined metal pipe above the softening point of the terionomer composition; and (iii) allowing the metal pipe to cool.

The method comprises (i) heating a metal pipe above the softening point of the terionomer composition; (ii) pulling or inserting a pre-formed terionomer pipe or multilayer terionomer pipe into the heated metal pipe; and (iii) allowing the metal pipe to cool.

The method comprises (i) coating a layer of an adhesive or adhesion primer onto the outside surface of the terionomer pipe or multilayer terionomer pipe; and (ii) pulling or inserting the adhesive-treated terionomer pipe or multilayer terionomer pipe into the metal pipe.

The method comprises (i) coating a layer of an adhesive or adhesion primer onto the inside surface of the metal pipe; and (ii) pulling or inserting the terionomer pipe or multilayer terionomer pipe into the adhesive-treated metal pipe.

The method comprises (i) coating a layer of an adhesive or adhesion primer onto the outside surface of the terionomer pipe or multilayer terionomer pipe; (ii) pulling or inserting the adhesive-treated terionomer pipe or multilayer terionomer pipe into the metal pipe; (ii) heating the metal pipe above the softening point of the terionomer composition; and (iv) allowing the metal pipe to cool.

The method comprises (i) coating a layer of an adhesive or adhesion primer onto the inside surface of the metal pipe; (ii) pulling or inserting the terionomer pipe or multilayer terionomer pipe into the adhesive-treated metal pipe; (ii) heating the metal pipe above the softening point of the terionomer composition; and (iv) allowing the metal pipe to cool.

The method comprises (i) coating a layer of an adhesive or adhesion primer onto the outside surface of the terionomer pipe or multilayer terionomer pipe; (ii) heating a metal pipe above the softening point of the terionomer composition; (iii) pulling or inserting the adhesive-treated terionomer pipe or multilayer terionomer pipe into the heated metal pipe; and (iv) allowing the metal pipe to cool.

The method comprises (i) coating a layer of an adhesive or adhesion primer onto the inside surface of the metal pipe; (ii) heating the adhesively-treated metal pipe above the softening point of the terionomer composition; (iii) pulling or inserting the terionomer pipe or multilayer terionomer pipe into the heated metal pipe; and (iv) allowing the metal pipe to cool.

In a specific example, the method for adhering the terionomer pipe or multilayer terionomer pipe to the metal pipe comprises (a) descaling and cleaning the interior surface of the metal pipe; (b) heating the metal pipe to a temperature of about 150 to about 400° C., preferably about 150 to about 300° C. and most preferably of about 175 to about 225° C.; (c) pulling or inserting the terionomer liner (pipe) or terionomer multilayer liner (pipe) into the hot metal pipe; and (d) allowing the terionomer-lined metal pipe to cool to ambient conditions.

For example, preparing a terionomer lined metal pipe method with a self-adhered terionomer liner (pipe) includes descaling, degreasing and cleaning as described above. The metal pipe is then heated, as in an oven, a furnace, a gas ring burner, electrical resistive heating elements, radiant heaters, induction heating, high frequency electrical heaters and the like, and the heating may be discontinued throughout the remainder of the process or the metal pipe may be continuously heated, as through induction heating, throughout the process. The heating expands the metal pipe. A terionomer liner (pipe) or terionomer multilayer liner (pipe) is pulled or inserted into the hot metal pipe. The terionomer and multilayer terionomer liner preferably has an outside diameter (OD) that is no greater than about 0.1 inch (2.5 mm) less than the inside diameter (ID) of the unheated metal pipe, more preferably an OD no greater than about 0.05 inch (1.3 mm) less than the ID, even more preferably, an OD no greater than about 0.025 inch (0.64 mm) less than the ID. Most preferably, the terionomer and multilayer terionomer liner OD is about equivalent to the ID of the unheated metal pipe. As the heated metal pipe-terionomer liner structure cools, the metal pipe reduces in diameter and makes intimate contact with the outside surface of the terionomer liner, causing it to soften and self-adhere to the inside surface of the metal pipe. Alternatively, the terionomer liner (pipe) or multilayer terionomer liner (pipe) may be inserted into the metal pipe prior to heating.

If desired, prior to heating the metal pipe and inserting the terionomer and multilayer terionomer liner (pipe), an adhesive primer, coating or layer may be applied to the interior surface of the metal pipe, the exterior surface of the terionomer and multilayer terionomer liner or both, in the form of a solution or solid to provide enhanced interlayer adhesion.

A method to produce a terionomer-lined metal pipe comprises laying up a pre-formed terionomer film or sheet or multilayer terionomer film or sheet into a preformed metal pipe. This method to produce a terionomer-lined metal pipe includes the following embodiments.

The method comprises (i) laying up the interior of a metal pipe with terionomer film or sheet or multilayer terionomer film or sheet; (ii) heating a metal pipe above the softening point of the terionomer composition; and (iii) allowing the metal pipe to cool.

The method comprises (i) coating a layer of an adhesive or adhesion primer onto the outside surface of the terionomer film or sheet or multilayer terionomer film or sheet; and (ii) laying up the interior of a metal pipe with terionomer film or sheet or multilayer terionomer film or sheet.

The method comprises (i) coating a layer of an adhesive or adhesion primer onto the inside surface of the metal pipe; and (ii) laying up the interior of a metal pipe with terionomer film or sheet or multilayer terionomer film or sheet.

The method comprises (i) coating a layer of an adhesive or adhesion primer onto the outside surface of the terionomer film or sheet or multilayer terionomer film or sheet; (ii) laying up the interior of a metal pipe with terionomer film or sheet or multilayer terionomer film or sheet; (iii) heating a metal pipe above the softening point of the terionomer composition; and (iv) allowing the metal pipe to cool.

The terionomer film or sheet and the multilayer terionomer film or sheet may be produced by any art method. Preferably the film or sheet is produced through melt processes, such as extrusion blown film processes, extrusion film or sheet melt casting processes, sheet profile extrusion processes, calendar processes and the like. The films and sheets may undergo secondary formation processes, such as the plying together of preformed sheets to produce thicker sheets through known calendaring processes.

An example terionomer lined metal pipe method with a self-adhered terionomer sheet includes descaling the interior of the metal pipe, followed by degreasing and cleaning. The interior of the metal pipe is then covered with the terionomer sheet, preferably with the sheet overlapping onto itself 0.5 to 4 inches to form a seam. The seam may be heat fused or the excess sheet may be trimmed and the sheet ends may be heat fused, as desired. The metal pipe is then heated, as described above, to the temperature range of about 150 to about 400° C., preferably to the temperature range of about 150 to about 300° C. and most preferably to the temperature range of about 175 to about 225° C. As the heated metal pipe-terionomer sheet structure cools, the metal pipe makes intimate contact with the outside surface of the terionomer sheet, causing it to soften and self-adhere to the inside surface of the metal pipe.

If desired, prior to heating the metal pipe and inserting the terionomer and multilayer terionomer film or sheet, an adhesive primer, coating or layer may be applied to the interior surface of the metal pipe, the exterior surface of the terionomer and multilayer terionomer film or sheet or both, in the form of a solution or solid to provide enhanced interlayer adhesion.

The terionomer-lined metal pipe may be produced by powder coating processes. Methods for coating the inner or outer surfaces of a pipe with polymeric powder coatings are known (U.S. Pat. Nos. 3,004,861; 3,016,875; 3,063,860; 3,074,808; 3,138,483; 3,186,860; 3,207,618; 3,230,105; 3,245,824; 3,307,996; 3,488,206; 3,532,531; 3,974,306; 3,982,050; 4,007,298; 4,481,239; and EP778088). The terionomer composition may be produced in the form of a powder by any known method. Methods for producing powders comprising acid copolymers and ionomers are known (U.S. Pat. Nos. 3,933,954; 4,056,653; 4,237,037; 6,107,412; 6,132,883; 6,284,311; 6,544,596; 6,680,082; and EP1169390). Preferably, the terionomer composition is cryogenically (for example, with liquid nitrogen as the cooling medium) ground into a powder. Physically grinding the terionomer composition creates irregularly shaped particles of size and shape suitable for achieving constant flow through the application equipment. Preferably, the terionomer composition powder has a particle size or average particle size of about 20 to about 500 μm. To obtain the suitable particle size, the grinding step may include a sieving or classification step to eliminate large- and fine-sized particles. For fluid bed coating processes, the preferred particle size is of about 75 to about 350 μm. Ionomer powder coating compositions are known (U.S. Pat. Nos. 3,959,539; 5,344,883; 6,132,883; 6,284,311; 6,544,596; and 6,680,082). For example, U.S. Pat. No. 4,407,893 discloses powder coating processes to produce abrasion-resistant pipes with 0.04-inch thick coatings of sand-filled blends comprising polyethylenes and ionomers and U.S. Pat. No. 6,680,082 discloses ionomer powders neutralized with more than one metal ion and their use as metal coatings.

A method to produce a terionomer-lined metal pipe comprises (i) heating a metal pipe above the softening point of a terionomer composition; (ii) fluidizing the terionomer composition in the form of a powder; (iii) supplying the fluidized terionomer composition powder to the inside of the heated metal pipe until the desired terionomer thickness is achieved; and (iv) allowing the metal pipe to cool.

The heated metal pipe may be in a vertical orientation during step (iii); or the heated metal pipe may be in a horizontal orientation during step (iii). In another embodiment, the heated metal pipe may be rotated during step (iii). For example, the heated metal pipe may be rotated at a rate to force the terionomer composition powder to the inside diameter of the metal pipe during step (iii).

The powder coating process comprises heating the metal pipe to a temperature above the softening point of the terionomer composition and supplying a fluidized powder of the terionomer composition into the heated pipe for a time sufficient to provide the desired terionomer coating thickness. The metal pipe is preferably heated to the temperature range of about 150 to about 400° C., preferably about 200 to about 350° C. and most preferably about 250 to about 300° C. The metal pipe may be heated as described above and the heating may be discontinued throughout the remainder of the process or the metal pipe may be continuously heated throughout the process. In addition, portions of the pipe may be heated. For example, in a fluidized bed method (see below) the metal pipe may be incrementally heated from the top to the bottom to cause the coating to form sequentially from the top to the bottom. Conversely, the metal pipe may be heated from the bottom to the top.

The terionomer coating may be self-adhered to the metal pipe or the interior surface of the metal pipe may be treated with adhesion primers, coatings and layers. The use of adhesion promoting primers and coupling agents for pipe powder coatings is known (U.S. Pat. Nos. 3,016,875; 4,048,355; and 4,481,239).

Pipe powder coating methods may include descaling, degreasing and cleaning as described above. The portions of the pipe which are not desired to be coated, for example the metal pipe ends which are meant to be joined together to form the pipeline, may be masked. If desired, prior to feeding the powder, an adhesive primer, coating or layer may be applied to the interior surface of the metal pipe in the form of a solution or solid (powder) to provide enhanced interlayer adhesion. The metal pipe is then heated as described above. The metal pipe temperature may be varied as desired during the coating operation. Preferably, the heated metal pipe may be rotated about its cylindrical axis at a rate of about 1 to about 300 rpm, more preferably about 10 to about 80 rpm. The metal pipe may be rotated slowly to provide good, even coverage of the powder coating or may be rotated fast enough to force the powder to the interior surface of the pipe. The metal pipe may be in a vertical orientation or preferably in a horizontal orientation. If a multilayer coating is desired, different polymeric composition powders may be fed sequentially to provide the different coating layers at the thickness desired. At any stage of the process, abrasion-resistant particles, such as described above as fillers, may be fed into the interior of the metal pipe, either individually or in combination with the powder. For example, the abrasion-resistant particles may be overcoated onto the hot coating while it is still soft and tacky so that the particles adhere to the interior surface of the coating. The coated metal pipe is then allowed to cool to ambient temperatures. If desired, any coating surface roughness may be smoothed through a post-coating operation, such as by hot gas, flame or oven post-treatments.

In a fluidized bed method, the powder is fed with pressurized gas, such as compressed air, nitrogen or argon, from a fluidized bed of the powder into the interior of the hot metal pipe. Alternatively, the hot metal pipe may be placed above the fluidized bed and the fluidized bed allowed to expand into the interior of the hot metal pipe to be coated. As the powder contacts the heated interior surface of the metal pipe, the material coalesces and flows to form a continuous, fused coating. The powder is fed from the fluidized bed until a continuous, uniform coating of the desired thickness is achieved.

In a spray coating method, a spray nozzle, preferably with a deflector disc to force the powder radially out onto the metal pipe interior surface, supported on an extensible boom, is inserted down the centerline of the metal pipe interior. The powder may be fed with pressurized gas, such as compressed air, nitrogen or argon, from a fluidized bed of the powder. Alternatively, the powder may be delivered from a bin to a vibrating feeder into a hopper and then conveyed to the spray nozzle with a pressurized gas. During the coating operation, the spray nozzle, the metal pipe or both may be moved to ensure uniform coating over the interior surface of the pipe. Multiple coats may be applied to provide the desired coating thicknesses.

The terionomer composition powder may be applied to the inside metal pipe surface by electrostatic spraying processes. For electrostatic spraying applications, the preferred particle size is about 20 to about 120 μm. Preferably, the metal pipe is preheated above the softening point of the terionomer composition as described above. In electrostatic spraying processes, the terionomer powder is fed out of a reservoir, such as a fluidized bed, to a spray gun through air pressure. A high voltage, low amperage electrostatic charge is applied to the terionomer powder by a transfer of electrons from the spray gun to the powder. The charged powder is sprayed onto the cleaned inside surface of the preheated, grounded metal pipe to form the terionomer coating. Several passes may be needed to provide the desired thickness of the coating.

The terionomer composition coating may be applied to the metal pipe by thermal spraying processes, such as flame (combustion) spraying, two wire arc spraying, plasma spraying, cold spraying and high velocity oxy-fuel spraying. Preferably, the thermal spraying process is a flame spraying process. The terionomer composition may be in the form of a wire or a rod to serve as a feedstock for flame spraying processes, or it is a powder with a preferred particle size of about 1 to about 50 μm. The terionomer powder is fed to the flame spraying gun in a stream of an inert gas (such as argon or nitrogen) and fed into a flame of a fuel gas (such as acetylene or propane) and oxygen. The terionomer powder is melted in the flame and with the help of a second outer annular gas nozzle of compressed air is sprayed onto the cleaned inside surface of the preheated metal pipe to form the terionomer coating. Several passes may be required to build up the thickness of the coating. Alternatively, the terionomer powder may be fed to the flame spray gun using a venturi effect sustained by the fuel gas flow.

The terionomer compositions may be too soft for the formation of suitable powder to support powder-based processes. Even if suitable powder were produced from the terionomer compositions, the powder may tend to mass (stick together). Powder-based processes to produce the pipe are therefore not preferred.

The terionomer-lined metal pipe may be produced by processes similar to the above mentioned rotational or slush molding processes. The terionomer composition may be in the form of powder, microbeads or pellets. The coating process comprises heating the metal pipe to a temperature above the softening point of the terionomer composition, horizontally rotating the pipe and supplying the terionomer composition into the heated pipe for a time sufficient to provide the desired terionomer coating thickness. The metal pipe can be preheated (such as in an oven), may be constantly heated during the process or both. The terionomer composition may be fed all at once, batchwise or continuously to the rotating heated metal pipe. After an even coating of the desired thickness of the terionomer composition is applied to the inner surface of the metal pipe, the pipe is cooled.

The pipes described herein provide high abrasion-resistance and corrosion resistance for the conveyance of solids and slurries such as found in the agriculture, food and mining industries. The terionomer layer in the pipes provides very long lifetime, especially desirable for those industries that require long service lifetime due to the great maintenance and replacement complexity and cost. For example, oil slurry mining operations require kilometers of slurry pipelines in extreme environments, such as northern Alberta, Canada, so extended pipe lifetime is very desirable.

A method for transporting an abrasive material comprises obtaining a pipe- or tube-formed article as described above; preparing an abrasive material composition suitable for flowing through the article; flowing the abrasive material composition into one end of the pipe- or tube-formed article and receiving the abrasive material composition out of the other end of pipe- or tube-formed article. The abrasive material composition may be moved through the pipe by any motive force such as gravity and/or the action of a pump such as a jet pump.

The abrasive material composition may be lurry, such as a combination of water, oil, air, emulsified materials, particulates, solids and/or the like. In some cases, the abrasive material, such as oil sand slurry, may be at a temperature of about 30° C. or greater, of about 40° C. or greater, or about 50° C. or greater. Oil sand slurries may be prepared as described in, for example, US2006/0249431. The oil sand slurry may be optionally conditioned by transport through the pipe- or tube-formed article, such conditioning comprising for example lump digestion, bitumen liberation, coalescence and/or aeration. Pumping the slurry through a pipeline over a certain minimum distance (such as at least one kilometer, preferably at least 2 kilometers), allows for conditioning the slurry. This is due to the increased time (such as 10 minutes or greater) in the pipeline, which allows transport through the pipeline to replace conditioning of the oil sand in a batch tumbler. In a low energy extraction process, the mined oil sand is mixed with water in predetermined proportions near the mine site to produce a slurry containing entrained air with density of 1.4 to 1.65 g/cc and preferably a temperature of 20-40° C. Pumping the slurry through a pipeline having a plurality of pumps spaced along its length, preferably adding air to the slurry as it moves through the pipeline, conditions the slurry for further operations to extract bitumen from the slurry.

### EXAMPLES

The following Examples are intended to be illustrative of the invention, and are not intended in any way to limit the scope of the invention.

Melt Index (MI) was measured by ASTM D1238 at 190° C. using a 2160 g mass, unless indicated otherwise. A similar ISO test is ISO 1133. Shore D hardness was measured according to ASTM D2240, ISO 868.

### Material Used

ION 1: a poly(ethylene-co-isobutylacrylate-co-methacrylic acid) containing 10 weight % isobutylacrylate and 10 weight % methacrylic acid based on the total weight of the parent acid terpolymer, partially neutralized with about 36% sodium ions, with an MI of about 1 g/10 min and Shore D hardness of 56.
ION 2: a poly(ethylene-co-n-butylacrylate-co-methacrylic acid) containing 17 weight % n-butylacrylate and 10 weight % methacrylic acid based on the total weight of the parent acid terpolymer, partially neutralized with about 49% sodium ions with an MI of about 1 g/10 min and Shore D hardness of 39.
ION 3: a poly(ethylene-co-n-butylacrylate-co-methacrylic acid) containing 23.5 weight % n-butylacrylate and 9 weight % methacrylic acid based on the total weight of the parent acid terpolymer, partially neutralized with about 52% sodium ions with an MI of about 1 g/10 min and a Shore D hardness of 36.
ION 5: a poly(ethylene-co-isobutylacrylate-co-methacrylic acid) containing 10 weight % isobutylacrylate and 10 weight % methacrylic acid based on the total weight of the parent acid terpolymer, partially neutralized with about 73% zinc ions with an MI of about 1 g/10 min and a Shore D hardness of 55.
ION 6: a poly(ethylene-co-n-butylacrylate-co-methacrylic acid) containing 23.5 weight % n-butylacrylate and 9 weight % methacrylic acid based on the total weight of the parent acid terpolymer, partially neutralized with about 51% zinc ions with an MI of about 0.6 g/10 min and a Shore D hardness of 40.
ION 7: a poly(ethylene-co-n-butylacrylate-co-methacrylic acid) having 23.5 weight % n-butylacrylate and 9 weight % methacrylic acid based on the total weight of the parent acid terpolymer, partially neutralized with about 49% magnesium ions, with MI of about 1 g/10 min and Shore D hardness of 43.
ION 8: a poly(ethylene-co-iso-butylacrylate-co-methacrylic acid) containing 20 weight % iso-butylacrylate and 15 weight % methacrylic acid, partially neutralized with about 27% zinc ions with an MI of about 2 g/10 min.
ION 9: a poly(ethylene-co-methylacrylate-co-acrylic acid) containing 25 weight % methylacrylate and 10 weight % acrylic acid, partially neutralized (about 30%) with a mixture of zinc ions and sodium ions in a 75:25 molar ratio with an MI of about 1 g/10 min.
ION 10 is a poly(ethylene-co-n-butylacrylate-co-methacrylic acid) containing 23.5 weight % n-butylacrylate and 9 weight % methacrylic acid based on the total weight of the parent acid terpolymer, partially neutralized (about 35%) with a mixture of zinc ions and sodium ions in a 50:50 molar ratio with an MI of about 5 g/10 min.
ION 11 is a poly(ethylene-co-n-butylacrylate-co-methacrylic acid) containing 17 weight % n-butylacrylate and 19 weight % methacrylic acid, partially neutralized with about 37% of zinc ions with an MI of 2 g/10 min.
ION 12: a filled composition of 50 wt % ION 6 and 50 wt % sand based on the total weight of the composition.
ION 13: a filled composition of 25 wt % ION 7 and 75 wt % silica based on the total weight of the composition.
ION 14: a filled composition of 75 wt % ION 6 and 25 wt % marble dust based on the total weight of the composition.
ACR: a poly(ethylene-co-n-butylacrylate-co-methacrylic acid) containing 23 wt % n-butylacrylate and 9 wt % methacrylic acid having a MI of 5 g/10 min.
EO: a metallocene-catalyzed ethylene-octene copolymer plastomer, sold as EXACT 5361 by ExxonMobil Chemical Company, Houston, Tex. (ExxonMobil).
EP1: a metallocene-catalyzed ethylene-propylene copolymer, sold as VISTALON EPM 722 by ExxonMobil.
EP2: a metallocene-catalyzed ethylene-propylene copolymer, sold as VISTAMAXX VM1100 by ExxonMobil.
EP3: EP2 grafted with 2 wt % maleic anhydride.
EPDM: a metallocene-catalyzed ethylene-propylene-diene copolymer, sold as VISTALON 5601 by ExxonMobil.
HDPE1: a high density poly(ethylene).
HDPE2: a high density poly(ethylene) grafted with 1.5 wt % maleic anhydride.
S: a styrene block copolymer sold as KRATON G7705-1 by Kraton Polymers, Houston, Tex. (Kraton).
SBS: a styrene-butadiene-styrene block copolymer with MI of 3 g/10 min at 200° C./5 kg, sold as KRATON D1153E (Kraton).
SEBS 1: a styrene-ethylene/styrene block copolymer with MI of 5 g/10 min at 230° C./5 kg, sold as KRATON G1652M (Kraton).
SEBS 2: a styrene-ethylene/styrene block copolymer grafted with 1.7 wt % maleic anhydride, sold as KRATON FG1901X (Kraton).
SEBS 3: a styrene-ethylene/styrene block copolymer grafted with 1 wt % maleic anhydride, sold as KRATON FG1924X (Kraton).
SIS: a styrene-isoprene-styrene block copolymer with MI of 3 g/10 min at 200° C./5 kg, sold as KRATON D111K (Kraton).

Thickness and diameter in the following tables, unless specifically indicated, are in inches (1 inch=2.54 cm).

### Comparative Examples CE1-CE2 and Examples 1-4

Abrasion resistance was assessed according to the following procedure. Wear test coupons were cut from injection molded plaques of the ionomers summarized in Table 1. The wear test coupons were 50 mm by 50 mm by 6.35 mm thick. The wear test coupons were dried in a vacuum oven (20 inches Hg) at room temperature for at least 15 hours and then weighed. The wear test coupons were then mounted in a test chamber and a 10 wt % aqueous sand (AFS50-70 test sand) slurry at room temperature (20 to 25° C.) was impinged on the wear test coupon through a slurry jet nozzle positioned 100 mm from its surface with a diameter of 4 mm at a slurry jet rate of 15-16 meters/second with a slurry jet angle of 90° relative to the surface plane for 2 hours. The wear test coupons were then removed and dried in a vacuum oven (20 inches Hg) at room temperature for at least 15 hours and then reweighed. The results are reported in Table 1.

TABLE 1

| | | Initial Weight | Final Weight | Weight Loss | |
|---|---|---|---|---|---|
| Example | Material | (grams) | (grams) | (grams) | (wt %) |
| CE1 | ION 1 | 9.1257 | 9.0919 | 0.0338 | 0.37 |
| 1 | ION 2 | 9.6866 | 9.6560 | 0.0306 | 0.32 |
| 2 | ION 3 | 9.2390 | 9.2132 | 0.0258 | 0.28 |
| CE2 | ION 5 | 9.6631 | 9.6417 | 0.0214 | 0.22 |
| 3 | ION 6 | 9.0577 | 9.0431 | 0.0146 | 0.16 |
| 4 | ION 7 | 9.4865 | 9.4881 | 0.0184 | 0.19 |

### Comparative Examples CE3-CE4 and Examples 5-8

Wear test coupons were tested as described above for Example 1 except the sand slurry was impinged on the wear test coupon at a slurry jet angle of 25° relative to the surface plane. The results are reported in Table 2.

TABLE 2

| | | Initial Weight | Final Weight | Weight Loss | |
|---|---|---|---|---|---|
| Example | Material | I(grams) | (grams) | (grams) | (wt %) |
| CE3 | ION 1 | 9.0930 | 9.0651 | 0.0279 | 0.31 |
| 5 | ION 2 | 9.6560 | 9.6259 | 0.0301 | 0.31 |
| 6 | ION 3 | 9.2132 | 9.1881 | 0.0251 | 0.27 |
| CE4 | ION 5 | 9.6417 | 9.6236 | 0.0181 | 0.19 |
| 7 | ION 6 | 9.0431 | 9.0297 | 0.0134 | 0.15 |
| 8 | ION 7 | 9.4681 | 9.4498 | 0.0183 | 0.19 |

### Comparative Examples CE5 and Examples 9-10

Wear test coupons were tested as described above for Example 1 except that the wear test coupons were dried in a vacuum oven (20 inches Hg) at a temperature of 35° C. until the weight loss was less than 1 mg/day prior to treating with the aqueous sand slurry at a temperature of 50° C., with the results summarized in Table 3.

TABLE 3

| | | Initial Weight | Final Weight | Weight Loss | |
|---|---|---|---|---|---|
| Example | Material | (grams) | (grams) | (grams) | (wt %) |
| CE5 | ION 5 | 8.2988 | 8.2825 | 0.0163 | 0.20 |
| 9 | ION 6 | 8.9339 | 8.9296 | 0.0043 | 0.05 |
| 10 | ION 7 | 9.2138 | 9.2077 | 0.0061 | 0.07 |
| 11 | ION 6 | 109.7108 | 109.6923 | 0.0185 | 0.02 |

### Example 11

A coated carbon steel pipe was produced by a rotational coating process. Pellets of ION 6 (0.45 kilograms) were placed in a 5.08-cm inner diameter (ID) steel pipe with a length of 50.8 cm. The pipe was rotated along its length at 30 revolutions per minute (rpm) and heated to 275° C. with an external oven. After reaching 275° C., the rotation rate was increased to 120 rpm for 1.5 hours. The coated pipe was then cooled to provide a steel pipe with an internal coating of ION 6 with a thickness of 6.35 to 8.47 mm. A wear test coupon was cut out of the pipe and tested as described above for Example 9, with the results summarized above in Table 3.

### Examples 12-20

The terionomer pipes summarized in Table 4 are made from the materials listed through conventional pipe extrusion and sizing methods with melt extrusion temperatures in the range from about 150° C. to about 225° C. The pipes are cut into 20 foot lengths. “OD”=outer diameter.

TABLE 4

| Example | Material | OD | Thickness |
|---|---|---|---|
| 12 | ION 6 | 20 | 0.5 |
| 13 | ION 7 | 24 | 1.0 |
| 14 | ION 8 | 28 | 2.0 |
| 15 | ION 9 | 22 | 0.38 |
| 16 | ION 10 | 26 | 0.75 |
| 17 | ION 11 | 32 | 1.5 |
| 18 | ION 12 | 26 | 0.4 |
| 19 | ION 13 | 30 | 1.0 |
| 20 | ION 14 | 34 | 1.8 |

### Examples 21-26

Terionomer bilayer pipes summarized in Table 5 are made from the materials in Table 5 through conventional multilayer pipe extrusion and sizing methods with melt extrusion temperatures in the range from about 150° C. to about 225° C. The pipes are cut into 20 foot lengths.

TABLE 5

| | Inner Layer | | Outer Layer | | |
|---|---|---|---|---|---|
| Example | Material | Thickness | Material | Thickness | OD |
| 21 | ION 6 | 0.5 | ACR | 0.25 | 20 |
| 22 | ION 7 | 1.0 | EPDM | 0.4 | 24 |
| 23 | ION 9 | 2.0 | HDPE 1 | 0.5 | 28 |
| 24 | ION 13 | 0.38 | SEBS 2 | 0.2 | 22 |
| 25 | ION 14 | 0.75 | SEBS 3 | 0.3 | 26 |
| 26 | ION 6 | 1.5 | HDPE 2 | 0.5 | 32 |

### Examples 27-35

Multilayer terionomer pipes are made from the materials summarized in Table 6 by conventional multilayer pipe extrusion and sizing methods with melt extrusion temperatures of about 150° C. to about 225° C. The tielayer is about 1-2 mils thick (0.026-0.051 mm) and is positioned between the inner layer and outer layer to provide adhesion. All Examples also have a tielayer on the outside surface of the outer layer, e.g.; the structure of the pipe is tielayer/outer layer/tielayer/inner layer. The pipes are cut into 20-foot lengths.

TABLE 6

| | Inner Layer | | Tie Layer | Outer Layer | | |
|---|---|---|---|---|---|---|
| Example | Material | Thickness | Material | Material | Thickness | OD |
| 27 | ION 6 | 0.5 | EP 3 | EO | 0.25 | 20 |
| 28 | ION 7 | 1.0 | EP 3 | EP 1 | 0.4 | 24 |
| 29 | ION 8 | 2.0 | EP 3 | EP 2 | 0.5 | 28 |
| 30 | ION 9 | 0.38 | EP 3 | EPDM | 0.2 | 22 |
| 31 | ION 10 | 0.75 | HDPE 2 | HDPE 1 | 0.3 | 26 |
| 32 | ION 11 | 1.5 | SEBS 2 | S | 0.5 | 32 |
| 33 | ION 12 | 0.45 | SEBS 3 | SBS | 0.2 | 26 |
| 34 | ION 13 | 1.0 | SEBS 2 | SEBS 1 | 0.1 | 30 |
| 35 | ION 14 | 1.8 | SEBS 2 | SIS | 0.3 | 34 |

### Examples 36-42

The terionomer pipe-lined carbon steel pipes summarized in Table 7 are made by inserting the terionomer pipes listed into 20-foot lengths of carbon steel pipes with 0.75-inch wall thickness with the inner diameter (ID) listed. Prior to lining the pipe, the interior surface of the carbon steel pipe is sandblasted and degreased.

TABLE 7

| | Terionomer pipe | Carbon steel pipe |
|---|---|---|
| Example | (Example) | ID |
| 36 | 12 | 22 |
| 37 | 16 | 28 |
| 38 | 19 | 32 |
| 39 | 22 | 26 |
| 40 | 26 | 34 |
| 41 | 30 | 24 |
| 42 | 33 | 28 |

### Examples 43-50

The terionomer pipe-lined pipelines summarized in Table 8 are made by thermally fusing the ends (“butt fusion”) of the terionomer pipes listed through conventional methods and inserting the polymeric pipes into the carbon steel pipes with 0.75-inch wall thickness and the length and the inner diameter (ID) listed. Prior to lining the pipe, the interior surface of the carbon steel pipe is sandblasted and degreased.

TABLE 8

| | |
|---|---|
| Terionomer Pipe | Carbon Steel Pipeline |

| Example | (Example) | ID | Length (km) |
|---|---|---|---|
| 43 | 13 | 26 | 1 |
| 44 | 15 | 24 | 2 |
| 45 | 20 | 36 | 3 |
| 46 | 21 | 22 | 0.5 |
| 47 | 23 | 30 | 1.5 |
| 48 | 28 | 26 | 1 |
| 49 | 33 | 28 | 2 |
| 50 | 34 | 32 | 3 |

### Examples 51-72

The terionomer pipe-lined carbon steel pipes summarized in Table 9 are made by heating 20 foot lengths of carbon steel pipes with 0.75-inch wall thickness and the inner diameter (ID) listed to 200° C.; inserting the terionomer pipes listed into the hot carbon steel pipes; and allowing the lined pipe to cool to ambient temperatures. Prior to lining the pipe, the interior surface of the carbon steel pipe is sandblasted and degreased.

TABLE 9

| | Terionomer Pipe | Carbon Steel Pipe |
|---|---|---|
| Example | (Example) | ID |
| 51 | 12 | 20 |
| 52 | 13 | 24 |
| 53 | 14 | 28 |
| 54 | 15 | 22 |
| 55 | 16 | 26 |
| 56 | 17 | 32 |
| 57 | 18 | 26 |
| 58 | 19 | 30 |
| 59 | 20 | 34 |
| 60 | 21 | 20 |
| 61 | 24 | 22 |
| 62 | 25 | 26 |
| 63 | 26 | 32 |
| 64 | 27 | 20 |
| 65 | 28 | 24 |
| 66 | 29 | 28 |
| 67 | 30 | 22 |
| 68 | 31 | 26 |
| 69 | 32 | 32 |
| 70 | 33 | 26 |
| 71 | 34 | 30 |
| 72 | 35 | 34 |

### Preparative Examples PE1-PE 9

Terionomer sheets with a thickness of 0.125 inch and a width of 9 feet are made from the materials summarized in Table 10 by conventional sheet extrusion methods with melt extrusion temperatures of about 1 50° C. to about 225° C. The sheets are plied together by conventional calendering processes to provide the described thickness.

TABLE 10

| Preparative Example | Material | Sheet Thickness |
|---|---|---|
| PE1 | ION 6 | 0.5 |
| PE2 | ION 7 | 1.0 |
| PE3 | ION 8 | 2.0 |
| PE4 | ION 9 | 0.25 |
| PE5 | ION 10 | 0.75 |
| PE6 | ION 11 | 1.5 |
| PE7 | ION 12 | 0.5 |
| PE8 | ION 13 | 1.0 |
| PE9 | ION 14 | 1.75 |

### Examples 73-81

The terionomer-lined carbon steel pipes summarized in Table 11 are made by inserting the terionomer sheets listed into 20 foot lengths of carbon steel pipes with 0.75-inch wall thickness with the inner diameter (ID) listed. Prior to lining the pipe, the interior surface of the carbon steel pipe is sandblasted and degreased. The terionomer sheets are cut down in size to fit the carbon steel pipe and the seam is butt welded by thermally fusing the ends (“butt fusion”). The terionomer-lined carbon steel pipe is heated to 200° C. while being rotated in the horizontal axis, and then the lined pipe is cooled to ambient temperatures.

TABLE 11

| | Terionomer Sheet | Carbon Steel Pipe |
|---|---|---|
| Example | (Example) | ID |
| 73 | PE1 | 22 |
| 74 | PE2 | 28 |
| 75 | PE3 | 32 |
| 76 | PE4 | 26 |
| 77 | PE5 | 34 |
| 78 | PE6 | 24 |
| 79 | PE7 | 28 |
| 80 | PE8 | 20 |
| 81 | PE9 | 30 |

1. A pipe- or tube-shaped article having an innermost layer wherein
the innermost layer has a thickness of about 0.001 to about 102 mm and comprises a terionomer composition;
the terionomer is made from an acid terpolymer comprising an α-olefin having 2 to 10 carbons, about 12 to about 60 wt % based on the total weight of the parent acid terpolymer of an α,β-ethylenically unsaturated carboxylic acid ester, and about 5 to about 25 wt % based on the total weight of the parent acid terpolymer of an α,β-ethylenically unsaturated carboxylic acid having 3 to 8 carbons; and about 5 to about 90% of the carboxylic acids are neutralized with a metal ion.

2. The article of claim 1 wherein the α-olefin consists essentially of ethylene; the α,β-ethylenically unsaturated carboxylic acid ester is methyl acrylate, ethyl acrylate, isopropyl acrylate, butyl acrylate or mixtures thereof; the α,β-ethylenically unsaturated carboxylic acid is acrylic acid, methacrylic acid or mixtures thereof; the parent acid terpolymer comprises about 15 to about 30 wt % of an α,β-ethylenically unsaturated carboxylic acid ester.

3. The article of claim 2 wherein the parent acid terpolymer comprises about 7 to about 20 wt % of an α,β-ethylenically unsaturated carboxylic acid and about 10 to about 50% of the carboxylic acids are neutralized with sodium ion, lithium ion, magnesium ion, zinc ion, or mixtures of two or more thereof.

4. The article of claim 2 further comprising from about 0.1 wt % to about 80 wt %, based on the total weight of the terionomer composition, of abrasion-resistant filler.

5. The article of claim 2 further comprising an outer layer having a thickness of about 0.1 to about 102 mm and the outer layer comprises rubber, elastomer, thermoplastic elastomer, acid terpolymer, ionomer terpolymer, or mixtures of two or more thereof.

6. The article of claim 2 further comprising an outer layer comprising a fiber reinforcement material comprising a high strength fiber and optionally a thermoset resin wherein the high strength fiber is produced from fiberglass, continuous glass fiber, polyaramide fiber, aramid fiber, graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, or polyamide.

7. The article of claim 6 further comprising an intermediate layer comprising rubber, elastomer, thermoplastic elastomer, acid terpolymer, ionomer terpolymer, or mixtures of two or more thereof.

8. The article of claim 6 wherein the high strength fiber is filament, warp yarn, unidirectional sheet, mat, cloth, knitted cloth, paper, non-woven fabric, woven fabric, or mixtures of two or more thereof.

9. The article of claim 2 comprising an outermost layer.

10. The article of claim 9 wherein the innermost layer is in contact with the outermost layer which comprises carbon steel, steel, stainless steel, cast iron, galvanized steel, aluminum, or copper, or alloys of two or more thereof.

11. The article of claim 9 wherein the outermost layer comprises carbon steel.

12. The article of claim 4 comprising an outermost layer.

13. The article of claim 12 wherein the innermost layer is in contact with the outermost layer which comprises carbon steel, steel, stainless steel, cast iron, galvanized steel, aluminum, or copper, or alloys of two or more thereof.

14. The article of claim 13 wherein the outermost layer comprises carbon steel.

15. The article of claim 8 comprising a metal outermost layer comprising carbon steel, steel, stainless steel, cast iron, galvanized steel, aluminum, or copper, or alloys of two or more thereof.

16. The article of claim 15 wherein the innermost layer is in contact with the outermost layer.

17. The article of claim 16 wherein the outermost layer comprises carbon steel.

18. A method comprising laying up a pre-formed film or sheet into a preformed metal pipe to produce ionomer-lined metal pipe wherein the film or sheet is monolayer or multilayer film or sheet and is produced from a terionomer composition; and the pre-formed film or sheet is as recited in claim 3.

19. The method of claim 18 further comprising heating the metal pipe above the softening point of the ionomer composition and allowing the metal pipe to cool to produce the ionomer-lined metal pipe.

20. A method for transporting an abrasive material comprising obtaining a pipe- or tube-formed article as characterized in claim 1; preparing an abrasive material composition suitable for flowing through the article; flowing the abrasive material composition into one end of the pipe- or tube-formed article and receiving the abrasive material composition out of the other end of pipe- or tube-shaped article.
